(19) United States
(12) Patent Application Publication
(10) Pub. No.: US 2025/0327239 A1
(43) Pub. Date: Oct. 23, 2025

(54) THERMALLY CONDUCTIVE FABRICS

(71) Applicant: Innofa USA LLC, Eden, NC (US)

(72) Inventor: Johan Cleyman, Greensboro, NC (US)

(21) Appl. No.: 19/185,118

(22) Filed: Apr. 21, 2025

Related U.S. Application Data
(60) Provisional application No. 63/636,464, filed on Apr. 19, 2024.

(51) Int. Cl. D06M 11/74; B32B 5/02; D06M 11/84; D06M 15/227; D06M 15/333; D06M 15/564; D06M 23/08; D06M 101/32

(52) U.S. Cl. CPC D06M 11/74; B32B 5/02; D06M 11/84; D06M 15/227; D06M 15/333; D06M 15/564; D06M 23/08; B32B 2255/02; B32B 2255/20; B32B 2255/26; B32B 2262/0276; B32B 2264/108; B32B 2307/302; D06M 2101/32; D06M 2200/00

(57) ABSTRACT

A thermally conductive fabric includes a base fabric and thermally conductive particles secured to a surface of and/or embedded in the base fabric. The thermally conductive particles may be formed from graphite, expandable graphite, and/or graphene. The thermally conductive particles may be bonded or otherwise secured to the base fabric with an adhesive material. The thermally conductive fabric may optionally include a web material over a surface of the base fabric to which the thermally conductive particles have been applied. The thermally conductive fabric may have a high thermal conductivity and/or a high thermal effusivity. Methods for manufacturing such a thermally conductive fabric are also disclosed. Such a method may include applying thermally conductive particles and an adhesive material to a base fabric and, with the adhesive material, bonding or otherwise securing the thermally conductive particles to the base fabric.

### CROSS-REFERENCE TO RELATED APPLICATION

A claim for priority to the Apr. 19, 2024 filing date of U.S. Provisional Patent Application No. 63/636,464, titled THERMALLY CONDUCTIVE FABRICS (“the '464 Provisional Application”), is hereby made. The entire disclosure of the '464 Provisional application is hereby incorporated herein.

### TECHNICAL FIELD

This disclosure relates generally to fabrics and, more specifically, to thermally conductive fabrics. Even more specifically, this disclosure relates to a thermally conductive fabric that includes a base fabric that carries particles of a thermally conductive material, such as graphite, expandable graphite, and/or graphene, adhered to the base fabric. This disclosure also relates to methods for manufacturing a thermally conductive fabric by securing particles of a thermally conductive material, such as graphite, expandable graphite, and/or graphene, to a base fabric or otherwise incorporating particles of the thermally conductive material into a base fabric.

### RELATED ART

Heat often makes an individual uncomfortable. Thus, the retention of heat by fabrics that cover an individual's body cause discomfort to the individual. These include fabrics that are used to make athletic apparel, fabrics used in bedding, and fabrics used to manufacture covers for mattresses, which may retain heat as an individual sleeps.

Because of the discomfort associated with heat, the demand for fabrics that provide temperature regulating properties has increased across various sectors, including sportswear, bedding, and medical textiles. To meet the demand for high-performance textiles, the industry has turned to innovative materials and technologies designed to enhance the thermal management capabilities of fabrics.

One prevalent approach to providing fabrics with temperature regulating properties has been the integration of cooling yarns into textiles that are otherwise unable to provide desired temperature regulating properties. The use of cooling yarns formed from ultra-high molecular weight polyethylene (UHMWPE) and low-density polyethylene (LDPE) has been favored because of the cool-to-the-touch properties of these materials.

Moisture wicking fabrics have also been used for temperature regulation. Moisture wicking fabrics cool as moisture that is passively transported away from a body to be cooled (e.g., an individual, etc.) evaporates. The ability of moisture wicking fabrics to provide a cooling effect is, however, limited by a number of factors, including the amount of moisture generated, the humidity in the environment where the moisture wicking fabric is used, and airflow in the environment where the moisture wicking fabric is used. When too much moisture is generated, humidity in the surrounding environment is too high, and/or airflow in the surrounding environment is too low, the cooling effect provided by a moisture wicking fabric, if any cooling effect is provided, may be undesirably low.

Phase change materials (PCMs) have also been embedded within or coated onto textile fibers to provide fabrics with temperature regulating properties. PCMs can absorb, store, and release heat as they transition between solid and liquid states, thereby helping to regulate the temperature of a body to be cooled (e.g., an individual, etc.) by buffering against temperature fluctuations. While PCMs may be effective in maintaining a particular temperature (e.g., a temperature that is comfortable to an individual, etc.), the ability to maintain that temperature may be limited in hot environments over extended periods of heat exposure and/or under high-intensity thermal loads, as may occur during prolonged periods of activity. Moreover, fabrics that include PCMs often lack durability. Further, the inclusion of PCMs in a fabric may undesirably alter a feel and drape (i.e., pliability) of the fabric.

Even with recent advances, temperature regulating fabrics still suffer from limitations in terms of efficiency, durability, and adaptability to extreme or varied thermal conditions.

### SUMMARY

In one aspect, a method for manufacturing a thermally conductive fabric is disclosed. Such a method includes providing a base fabric. Optionally, the base fabric may be preheated. The method also includes applying particles of a thermally conductive material and an adhesive material to the base fabric. The particles of thermally conductive material and adhesive material may be substantially evenly applied or evenly applied to a surface (e.g., a lower surface, etc.) of the base fabric. While on the base fabric, the particles of thermally conductive material and the adhesive material may be heated to bond the adhesive material to adjacent particles of thermally conductive material and to the base fabric.

The particles of the thermally conductive material may also be referred to as “thermally conductive particles.” The thermally conductive material may have a high thermal conductivity, which is a measure of the ability of a material to conduct heat or, more specifically, the number of watts (W) conducted through the thickness (measured in meters (m)) of a material per a difference in temperature (K) from one side of the material to the other, or W/mK. For purposes of this disclosure, a material with a high thermal conductivity has a thermal conductivity of 25 W/mK or more. The thermally conductive material may also have a high thermal effusivity, which is the measure of a material to exchange heat with its surroundings or, more specifically, the square root of the product of the material's thermal conductivity and the material's volumetric heat capacity, measured in units of Ws^{1/2}/m²K. For purposes of this disclosure, a material with a high thermal effusivity has a thermal effusivity of at least 250 Ws^{1/2}/m²K. Examples of thermally conductive materials that may impart a fabric with high thermal conductivity and high thermal effusivity include graphite, expandable graphite (which may comprise flakes that expand when exposed to a sufficient temperature, e.g., about 200° C.), and graphene. The thermally conductive particles may include a single type of thermally conductive particle (e.g., graphite particles, expandable graphite particles, graphene particles, etc.) or a combination of different types of thermally conductive particles (e.g., two or more of graphite particles, expandable graphite particles, graphene particles, etc.).

The adhesive material may comprise particles of adhesive material, which may also be referred to as “adhesive particles.” Alternatively, the adhesive material may coat the thermally conductive particles. The adhesive material may adhere to the base fabric and to adjacent thermally conductive particles, thus adhering the thermally conductive particles to the base fabric. The adhesive material may comprise a thermoplastic material, which softens and then melts when heated. A heated thermoplastic material may wick or otherwise be forced into the fabric, enabling the thermoplastic material to mechanically engage the base fabric as the thermoplastic material cools. The thermoplastic material may also adhere to and, optionally, mechanically engage the thermally conductive particles. Examples of adhesive particles that comprise thermoplastic materials include, but are not limited to, ethylene vinyl acetates (EVAs) and thermoplastic polyurethanes (TPUs).

The thermally conductive particles and adhesive particles may be mixed together to form a homogenous mixture. Mixing may be conducted in any suitable manner. Alternatively, the thermally conductive particles may be coated with the adhesive material. As another alternative, a mixture of the thermally conductive particles and adhesive particles may be applied to (e.g., scattered onto, printed onto, etc.) a transfer sheet or adhesive-coated thermally conductive particles may be applied to a transfer sheet.

A base fabric may be selected. The base fabric may be of any desired composition (e.g., it may include synthetic fibers, synthetic fiber blends, natural fibers, natural fiber blends, blends of natural and synthetic fibers, etc.). The base fabric may have any desired weight (e.g., it may be ultra light (i.e. less than 100 g/m²), lightweight (i.e., 100 g/m² to 170 g/m²), midweight (i.e., 170 g/m² to 340 g/m²), heavyweight (i.e., 340 g/m² to 400 g/m²), or ultra heavy (i.e., more than 400 g/m²).

The base fabric may be preheated to a temperature that enables the adhesive material to temporarily adhere to a surface of the base fabric. Additionally, the temperature to which the base fabric is heated may enable the thermally conductive particles to temporarily adhere to the adhesive material.

The thermally conductive particles and adhesive material may be evenly applied to the surface of the base fabric in any suitable manner. As an example, a powder scattering process may scatter a mixture of the thermally conductive particles and adhesive particles substantially evenly or evenly across the surface of the base fabric. As another example, a powder scattering process may scatter adhesive-coated thermally conductive particles substantially evenly or evenly across the surface of the base fabric. As yet another example, a transfer sheet carrying a substantially evenly spread layer or an evenly spread layer of a mixture of thermally conductive particles and adhesive particles or a substantially evenly spread layer or an evenly spread layer of adhesive-coated thermally conductive particles may be placed against the surface of the base fabric.

Optionally, a web material may be positioned over the thermally conductive particles and adhesive material and superimposed with the base fabric. A weight of the web material may be ultra light (i.e., under 100 g/m² (GSM)) or lightweight (i.e., 100 g/m² to 170 g/m²). More specifically, the web material may have a weight of about 5 g/m² to about 200 g/m². The web material may comprise polyester, polyamide, polypropylene, or polyethylene. Alternatively, the web material may comprise (e.g., be made from, carry, etc.) the adhesive material; such a web material may be used in place of or in addition to the adhesive particles.

With the thermally conductive particles and adhesive material in place against the surface of the base fabric and the optional web material in place over the mixture, the base fabric, the thermally conductive particle, the adhesive material, and the optional web material may be subjected to sufficient heat and/or pressure to enable the adhesive material to adhere to base fabric and to adjacent thermally conductive particles. In embodiments where the adhesive material comprises a thermoplastic material, the heat and/or pressure may enable or cause the adhesive material to flow into the base fabric (e.g., into spaces between yarns from which the base fabric is formed (e.g., knit, woven, etc.), into yarns from which the base fabric is formed, etc., by wicking, by force under pressure, etc.). As adhesive material flows into and/or is pressed into the base fabric, some of the thermally conductive particles may also be forced into the base fabric (e.g., the adhesive material may be forced into the base fabric, the adhesive material may carry some of the thermally conductive particles into the base fabric, etc.). In embodiments where the optional web material is used, the web material may prevent the thermally conductive particles, the adhesive material, etc., from staining the equipment used to perform the method.

As the adhesive material is heated and/or pressed, an adhesive film or layer may be formed on the surface of the base fabric. A thickness of the adhesive film or layer and other characteristics of the adhesive film or layer (e.g., the extent to which it covers the surface of the base fabric, or its confluence, etc.) may correspond to a volume of adhesive material applied to the surface of the base fabric and to other factors, such as the size(s) of particles of the adhesive material, an amount of pressure or force applied to the adhesive material, etc. Accordingly, the thickness and other characteristics of the adhesive film or layer may be optimized by optimizing the collective volume of adhesive material applied to the surface of the base fabric, the size(s) of particles of the adhesive material, the amount of pressure applied to the adhesive material, etc. In embodiments where a sufficient volume of adhesive particles was applied to the surface of the base fabric and a sufficient pressure is applied to the adhesive material, the adhesive film or layer formed from the adhesive material may cover the entire surface to which the adhesive material was applied (i.e., it may be confluent). In embodiments where a minimized volume of adhesive material was applied to the surface of the base fabric and/or little or no pressure is applied to the adhesive material, the adhesive film or layer formed from the adhesive material may only cover portions (e.g., spots, a layer with holes, etc.) of the surface of the base fabric (i.e., the adhesive film or layer may be nonconfluent).

Following the application of heat and/or pressure to the mixture of thermally conductive particles and adhesive material, the thermally conducive fabric may be allowed to cool.

In another aspect, a thermally conductive fabric includes a base fabric with thermally conductive particles homogeneously distributed over a surface (e.g., a lower surface, etc.) of the base fabric. The thermally conductive fabric may also include an adhesive material (e.g., adhesive spots, an adhesive layer, etc.) that secures the thermally conductive particles to the base fabric.

The base fabric may comprise any type of fabric. For example, the base fabric may comprise a conventional fabric (i.e., an unenhanced fabric) that has low thermal conductivity, such as polyester, low-density polyethylene (LDPE) fabric, or the like. As another example, the base fabric may comprise a conventional fabric (i.e., an unenhanced fabric) with some thermal conductivity. As yet another example, the base fabric may comprise a fabric that has been made with a thermal conductivity-enhancing technology (e.g., a conventional thermal conductivity-enhancing technology, another thermal conductivity-enhancing technology, etc.).

The base fabric may have any desired weight (e.g., it may be ultra light (i.e., less than 100 g/m²), lightweight (i.e., 100 g/m² to 170 g/m²), midweight (i.e., 170 g/m² to 340 g/m²), heavyweight (i.e., 340 g/m² to 400 g/m²), or ultra heavy (i.e., more than 400 g/m²).

The thermally conductive particles may comprise a thermally conductive material with a high thermal conductivity. For example, the thermally conductive particles may comprise graphite particles, expandable graphite particles, graphene particles, etc., or mixtures of any of the foregoing. The thermally conductive particles may be dispersed over a surface of the fabric. More specifically, the thermally conductive particles may be evenly dispersed across the fabric, which may maximize the surface area of the thermally conductive fabric that collects, conducts, and dissipates heat.

Optionally, some of the thermally conductive particles may be located within the base fabric. As another option, the thermally conductive particles may be distributed throughout the base fabric.

The adhesive material adheres, secures, or bonds the thermally conductive particles to the base fabric. The adhesive material may comprise a thermoplastic material. The thermoplastic material may adhere to a surface of the base fabric. In some embodiments, the thermoplastic material may extend into the base fabric (e.g., into spaces between yarns from which the base fabric is formed (e.g., knit, woven, etc.), into yarns from which the base fabric is formed, etc., by wicking, by force under pressure, etc.). The thermoplastic material may comprise an EVA, a TPU, etc. Alternatively, the adhesive material may comprise another suitable type of material that will adhere, secure, or bond the thermally conductive particles to the base fabric. The adhesive material may define a film or layer on a surface of the base fabric. The film or layer may be confluent or nonconfluent.

Optionally, a web material may be positioned over the thermally conductive particles and superimposed with the base fabric. A weight of the web material may be ultra light (i.e., under 100 g/m² (GSM)) or lightweight (i.e., 100 g/m² to 170 g/m²). More specifically, a weight of the web material may be about 5 g/m² to about 200 g/m². The web material may be formed from polyester, polyamide, polypropylene, or polyethelene. Such web material may be secured in place with the adhesive material. Alternatively, the web material may comprise or carry the adhesive material and, thus, secure itself and the thermally conductive particles in place.

The thermally conductive particles and adhesive material may impart the thermally conductive fabric with good thermal conductivity while having a minimal effect on the feel and other properties of the fabric. Without limitation, the thermally conductive particles and adhesive material may maintain a feel and/or comfort of the fabric, the extent to which the fabric drapes (i.e., its pliability or flexibility), its stretchability, its durability, its breathability, and the like.

The thermally conductive fabric may be used to provide for efficient heat management, or heat distribution and thermal regulation. Without limitation, the thermally conductive fabric may conduct heat away from at least part of an individual's body. The thermally conductive fabric may conduct heat through its thickness. For example, the thermally conductive fabric may conduct heat from a first surface, or an internal surface, adjacent to a source of heat to a second surface, or an external surface. The thermally conductive fabric may also conduct the heat across its area, which may allow the heat to spread out over a larger area than the area that receives the heat. The heat can then dissipate into the environment in which the thermally conductive fabric and an article of manufacture made with the thermally conductive fabric are located. As heat moves away from the heat source, spreads out across the thermally conductive fabric, and/or dissipates, the thermally conductive fabric may feel cool to an individual's touch.

A few examples of articles of manufacture that may be made from the thermally conductive fabric include, without limitation, apparel (e.g., athletic wear, etc.), bedding (e.g., mattress covers, mattress pads, sheets, blankets, pillowcases, etc.), upholstery, and the like.

Other aspects of the disclosed subject matter, as well as features and advantages of various aspects of the disclosed subject matter, should become apparent to those of ordinary skill in the art through consideration of the ensuing description, the accompanying drawings, and the appended claims.

### BRIEF DESCRIPTION OF THE DRAWINGS

In the drawings,

FIG. 1 illustrates an embodiment of a thermally conductive fabric of this disclosure;

FIG. 2 illustrates another embodiment of a thermally conductive fabric of this disclosure; and

FIG. 3 is a schematic representation of an apparatus for forming a thermally conductive fabric of this disclosure.

### DETAILED DESCRIPTION

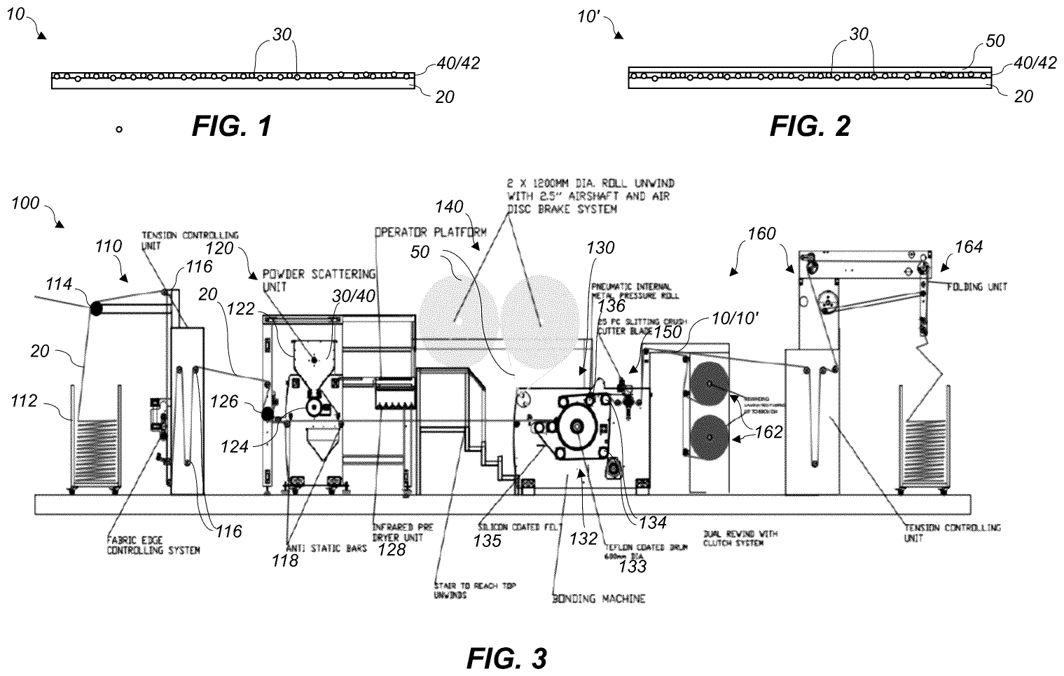

A thermally conductive fabric of this disclosure includes enhanced heat dissipation properties to create cooler wearing experiences and surfaces. As illustrated by FIG. 1, the thermally conductive fabric 10 includes a base fabric 20, thermally conductive particles 30, and an adhesive material 40. The thermally conductive particles 30 may reside on a surface of the base fabric 20 and/or extend into the base fabric 20. The adhesive material 40 may secure the thermally conductive particles 30 to the base fabric 20.

The base fabric 20 may comprise any suitable or desired fabric. Without limitation, the base fabric 20 may comprise a conventional fabric (i.e., an unenhanced fabric) that has low thermal conductivity, such as a polyester fabric, a low-density polyethylene (LDPE) fabric, or the like. As another example, the base fabric 20 may comprise a conventional fabric (i.e., an unenhanced fabric) with some thermal conductivity. As yet another example, the base fabric 20 may comprise a fabric that has been made with a thermal conductivity-enhancing technology (e.g., a conventional thermal conductivity-enhancing technology, another thermal conductivity-enhancing technology, etc.). The base fabric 20 may be of any desired composition (e.g., it may include synthetic fibers, synthetic fiber blends, natural fibers, natural fiber blends, blends of natural and synthetic fibers, etc.).

The base fabric 20 may have any desired weight (e.g., it may be ultra light (i.e. less than 100 g/m²), lightweight (i.e., 100 g/m² to 170 g/m²), midweight (i.e., 170 g/m² to 340 g/m²), heavyweight (i.e., 340 g/m² to 400 g/m²), or ultra heavy (i.e., more than 400 g/m²).

The thermally conductive particles 30 may comprise a thermally conductive material with a high thermal conductivity, or a thermal conductivity of 25 W/mK or more. The thermally conductive particles 30 may comprise graphite particles, expandable graphite particles, graphene particles, or mixtures of any of the foregoing.

Graphite is a crystalline form of carbon in which carbon atoms are arranged in a hexagonal pattern, forming layers that are loosely bonded together. The thermal conductivity of graphite is 25 W/mK to 470 W/mK. The specific heat capacity of graphite is 710 J/kgK to 830 J/kgK.

Expandable graphite is a form of intercalated graphite that can undergo significant expansion when exposed to heat. This expansion increases the surface area of the graphite, which in turn can enhance its ability to dissipate heat. Graphite can contribute to improved thermal regulation by creating pathways for heat.

Graphene is a single layer of carbon atoms arranged in a two-dimensional honeycomb lattice. The thermal conductivity of graphene is extremely high. The measured thermal conductivity of suspended graphene at room temperature (about 25° C.) is about 2,600 W/mK to about 5,300 W/mK.

The thermally conductive particles 30 may be dispersed across the base fabric 20 in such a way that the thermally conductive particles 30 are spaced apart from each other. Alternatively, the thermally conductive particles 30 may substantially cover the base fabric 20. The thermally conductive particles 30 may be substantially evenly dispersed across the base fabric 20 or the thermally conductive particles 30 may be evenly dispersed across the base fabric 20. Substantially even or even distribution of the thermally conductive particles 30 may maximize the surface area of the thermally conductive fabric 10 that collects, conducts, and dissipates heat.

At least some of the thermally conductive particles 30 may be carried by a surface 22 of the base fabric 20. At least some of the thermally conductive particles 30 may extend into the base fabric 20 (e.g., into spaces between yarns from which the base fabric 20 is formed (e.g., knit, woven, etc.), etc.).

The adhesive material 40 adheres, secures, or bonds the thermally conductive particles 30 to the base fabric 20. The adhesive material 40 may comprise a thermoplastic material. The thermoplastic material may adhere to a surface of the base fabric 20. In some embodiments, the thermoplastic material may extend (e.g., wick, bleed, seep, etc.) into the base fabric 20 (e.g., into spaces between yarns from which the base fabric 20 is formed (e.g., knit, woven, etc.), etc.). The thermoplastic material 40 may comprise an EVA, a TPU, or the like. A specific but nonlimiting example of a suitable EVA is an EVA 2048 powder with a particle size of about 100 μm to about 500 μm. A specific but nonlimiting example of a suitable TPU is TPU 4073, which is a high performance TPU. Alternatively, the adhesive material 40 may comprise another suitable type of material that will adhere, secure, or bond the thermally conductive particles 30 to the base fabric 20.

The adhesive material 40 may define a film or layer 42 on a surface 22 of the base fabric 20. The film or layer 42 may be confluent (i.e., cover the entire surface 22 of the base fabric) or nonconfluent (i.e., it may include regions of the adhesive material 40 that are spaced apart from each other).

A nonlimiting example of such a thermally conductive fabric 10 includes a base fabric 20 that is 100% polyester and thermally conductive particles 30 comprising graphite. The polyester base fabric 20 alone has a thermal conductivity of 0.09 W/mK to about 0.45 W/mK (e.g., about 0.38 W/mK, etc.). With the addition of a sufficient quantity of thermally conductive particles 30 that comprise graphite to the base fabric 20, the thermal conductivity of the resulting thermally conductive fabric 10 may be increased to 25 W/mK or more (e.g., 30 W/mK or more, 40 W/mK or more, 45 W/mK or more, 50 W/mK or more, etc.). The polyester base fabric 20 alone may have a thermal effusivity of about 100 Ws^{1/2}/m²K. With the addition of a sufficient quantity of thermally conductive particles 30 that comprise graphite to the base fabric 20, the thermal conductivity of the resulting thermally conductive fabric 10 may be increased to 250 Ws^{1/2}/m²K or greater (e.g., 300 Ws^{1/2}/m²K or greater, 350 Ws^{1/2}/m²K or greater, 400 Ws^{1/2}/m²K, etc.).

In another nonlimiting example, the base fabric 20 of a thermally conductive fabric 10 is LPDE. LDPE has a thermal conductivity of about 0.32 W/mK to about 0.36 W/mK and a thermal effusivity of about 200 Ws^{1/2}/m²K. While LDPE shows an improvement over standard polyester due to its inherent material properties, it still falls short in applications requiring optimal heat dissipation. A treatment of LDPE fabric with a finish application incorporating a phase change material on back of the fabric can increase the thermal effusivity of the LPDE fabric to 240 W s^{1/2}/m2 K. With the addition of sufficient thermally conductive particles 30 comprising graphite to the untreated base fabric 20 or the base fabric 20 that has been treated with the phase change material, the thermal conductivity of the resulting thermally conductive fabric 10 may be increased to 25 W/mK or more (e.g., 30 W/mK or more, 40 W/mK or more, 45 W/mK or more, 50 W/mK or more, etc.), while the thermal effusivity of the resulting thermally conductive fabric 10 may be increased to 250 Ws^{1/2}/m²K or greater (e.g., 300 Ws^{1/2}/m²K or greater, 350 Ws^{1/2}/m²K or greater, 400 Ws^{1/2}/m²K, etc.).

Addition of the thermally conductive particles 30 and adhesive material 40 to the base fabric 20 provides a thermally conductive fabric 10 that may substantially maintain the other properties of the base fabric 20 (e.g., its feel, its drape, its stretchability, its durability, its breathability, etc.).

Optionally, as illustrated by FIG. 2, a thermally conductive fabric 10′ may include a base fabric 20, thermally conductive particles 30, and an adhesive material 40, as described in reference to the thermally conductive fabric 10 shown in FIG. 1, as well as a web material 50 superimposed with the base fabric 20 and positioned over the surface 22 that carries the thermally conductive particles 30.

The web material 50 may be ultra light (i.e., less than 100 g/m²), lightweight (i.e., 100 g/m² to 170 g/m²) or midweight (i.e., 170 g/m² to 340 g/m²). The web material may have a weight of about 5 g/m² to about 200 g/m². The web material 50 may have a weight that is less than a weight of the base fabric 20. In some embodiments, a weight of the web material 50 may not add significantly to a weight of the base fabric 20. The combined weights of the base fabric 20 and the web material 50 may be in the same weight range as the base fabric 20 alone (e.g., ultra light, lightweight, midweight, heavyweight, etc.).

The web material 50 may comprise polyester, polyamide, polypropylene, or polyethelene. Such web material may be secured in place with the adhesive material. Alternatively, the web material may comprise or carry the adhesive material and, thus, secure itself and the thermally conductive particles 30 in place.

Addition of the thermally conductive particles 30, adhesive material 40, and web material 50 to the base fabric 20 provides a thermally conductive fabric 10′ that may substantially maintain the other properties of the base fabric 20 (e.g., its feel, its drape, etc.).

Turning now to FIG. 3, an embodiment of an apparatus 100 for forming a thermally conductive fabric 10, 10′ (FIGS. 1 and 2, respectively) of this disclosure is depicted. The apparatus 100 includes a feeder 110, an applicator 120, a bonder 130, and a collector 160. The apparatus 100 may optionally include a source 140 of web material 50 (FIG. 2).

The feeder 110 may include a source 112 for a base fabric 20 (FIGS. 1 and 2). The feeder 110 may include one or more motors 114 and pulleys 116 that convey the base fabric 20 into the apparatus 100 under a desired tension and convey the base fabric 20 through the apparatus 100 at a desired rate. The feeder 100 may optionally include one or more static eliminators 118 that remove static electricity from the base fabric 20 as it is conveyed into and through the apparatus 100.

Initially, the feeder 110 may convey the base fabric 20 into the applicator 120. The applicator 120 may include a source 122 for the conductive particles 30 and adhesive material 40. The applicator 120 may apply the thermally conductive particles 30 and adhesive material 40 to the base fabric 20 in any suitable manner. For example, as illustrated, the source 122 may be associated with a powder scatterer 124, which may dispense a mixture of the thermally conductive particles 30 and particles of the adhesive material 40 onto the base fabric 20 as the base fabric 20 is conveyed through the applicator 120. Alternatively, such a powder scatterer 124 may dispense adhesive material 40-coated thermally conductive particles 30 onto the base fabric 20 as the base fabric 20 is conveyed through the applicator 120. As an alternative to the illustrated source 122 and powder scatterer 124, the apparatus 100 may comprise a source (e.g., a roll, etc.) of a transfer sheet (e.g., a strip, a band, etc.; a transfer paper, etc.) to which the thermally conductive particles 30 and adhesive material 40 have been pre-applied (e.g., scattered onto, printed onto, etc.), and the transfer sheet may transfer the thermally conductive particles 30 and adhesive material 40 to the base fabric 20. In embodiments where a web material 50 is to be applied to the base fabric 20, the powder scatterer 124 may dispense the thermally conductive particles 30 but not any adhesive material 40.

Optionally, the applicator 120 may include one or more heaters 126, 128. For example, a heater 126 may preheat the base fabric 20 as it enters the applicator 120 and before the thermally conductive particles 30 and adhesive material 40 are applied to the base fabric 20. Such a heater 126 may preheat the base fabric 20 to a temperature that will heat the adhesive material 40 to a sufficient temperature to enable it to adhere to the base fabric 20 and the thermally conductive particles 30. As another example, a heater 128 may heat the base fabric 20 after the thermally conductive particles 30 and adhesive material 40 have been applied to it to enable the adhesive material 40 to adhere to the base fabric 20 and to the thermally conductive particles 30 and or to evaporate, or drive, any moisture from the base fabric 20, thermally conductive particles 30, and adhesive material 40. With the thermally conductive particles 30 and adhesive material 40 on the base fabric 20, any transfer sheet may be removed from the base fabric 20.

From the applicator 120, the feeder 110 may convey the base fabric 20, conductive particles 30, and any adhesive material 40 to the bonder 130. In embodiments where the apparatus 100 includes a source 140 of web material 50, the feeder 110 may also convey the web material 50 to the bonder 130. The bonder 130 may bond the conductive particles 30 and the web material 50, if any, to the base fabric 20. More specifically, the bonder 130 may cause or enable the adhesive material 40 and/or the web material 50 to bond the conductive particles 30 and the optional web material 50 to the base fabric 20.

The bonder 130 may include a conveyor 132 with a drum 133 (e.g., a Teflon coated drum, etc.) and a series of rollers 134 that carry and move a belt 135 (e.g., silicone coated felt, etc.) past a pressure roller 136. The belt 135 may carry the base fabric 20 and the optional web material 50 through the bonder 130 to enable the bonder 130 (e.g., the pressure roller 136, etc.) to apply heat and/or pressure to the adhesive material 40 and/or any web material 50 to at least partially melt the adhesive material 40 and/or any web material 50 and enable it/them to secure the thermally conductive particles 30 and the optional web material 50 to the base fabric 20. The result is a thermally conductive fabric 10 (FIGS. 1 and 2).

From the bonder 130, the feeder 110 may conveys the thermally conductive fabric 10 past an optional cutter 150. The cutter 150 may comprise any suitable cutter for fabric. Without limitation, the cutter 150 may comprise a crush cutter.

The thermally conductive fabric 10 is ultimately conveyed to a collector 160. The collector 160 may comprise one or more reels 162, which may receive and roll the thermally conductive fabric 10. Alternatively or additionally, the collector 160 may comprise a folder 164 folds and/or stacks the thermally conductive fabric 10.

Although the disclosure provides many specifics, the specifics should not be construed as limiting the scope of any of the claims, but merely as providing illustrations of some embodiments of elements and features of the disclosed subject matter that fall within the scopes of the claims. Other embodiments of the disclosed subject matter may be devised that are also within the scopes of the claims. Accordingly, the scope of each claim is limited only by its plain language and the legal equivalents thereto.

What is claimed:

1. A method for applying a thermally conductive material to a fabric, comprising:
mixing thermally conductive particles and adhesive particles together to form a homogenous mixture;
evenly applying the homogenous mixture to a surface of a base fabric; and
heating the homogenous mixture to bond the adhesive particles to adjacent thermally conductive particles and to the base fabric.

2. The method of claim 1, wherein mixing the thermally conductive particles and the adhesive particles together comprises mixing particles of graphite with the adhesive particles.

3. The method of claim 2, wherein mixing the particles of graphite with the adhesive particles comprises mixing particles of expandable graphite with the adhesive particles.

4. The method of claim 1, wherein mixing the thermally conductive particles and the adhesive particles together comprises mixing particles of graphene with the adhesive particles.

5. The method of claim 1, wherein mixing the thermally conductive particles and the adhesive particles together comprises mixing the thermally conductive particles with adhesive particles comprising an ethylene vinyl acetate (EVA).

6. The method of claim 1, wherein mixing the thermally conductive particles and the adhesive particles together comprises mixing the thermally conductive particles with adhesive particles comprising a thermoplastic polyurethane (TPU).

7. The method of claim 1, further comprising:
preheating the base fabric before evenly applying the homogenous mixture to the surface of the base fabric.

8. The method of claim 1, wherein evenly applying the homogenous mixture comprises powder scattering the homogenous mixture over the surface of the base fabric.

9. The method of claim 1, wherein evenly applying comprises positioning a transfer sheet carrying a layer of the homogenous mixture to the surface of the fabric.

10. The method of claim 1, wherein heating the homogenous mixture includes applying pressure to the homogenous mixture.

11. A method for applying a thermally conductive material to a fabric, comprising:
mixing thermally conductive particles comprising graphite, expandable graphite, and/or graphene and adhesive particles comprising ethylene vinyl acetate and/or thermoplastic polyurethane together to form a homogenous mixture;
evenly applying the homogenous mixture to a surface of a base fabric; and
heating and applying pressure to the homogenous mixture to bond the adhesive particles and adjacent thermally conductive particles to the base fabric.

12. The method of claim 11, wherein evenly applying the homogenous mixture comprises powder scattering the homogenous mixture over the surface of the base fabric.

13. The method of claim 11, wherein evenly applying comprises positioning a transfer sheet carrying a layer of the homogenous mixture to the surface of the base fabric.

14. The method of claim 11, further comprising:
applying a web material to the homogenous mixture on the surface of the base fabric.

15. A thermally conductive fabric, comprising:
a base fabric including a lower surface and an outer surface;
thermally conductive particles homogenously distributed over the lower surface of the base fabric; and
an adhesive material bonded to the thermally conductive particles and to the lower surface of the base fabric to bond the thermally conductive particles to the base fabric.

16. The thermally conductive fabric of claim 15, wherein the base fabric comprises polyester.

17. The thermally conductive fabric of claim 15, wherein the thermally conductive particles comprise graphite, expandable graphite, or graphene.

18. The thermally conductive fabric of claim 15, wherein the adhesive material comprises ethylene vinyl acetate (EVA) or a thermoplastic polyurethane (TPU).

19. The thermally conductive fabric of claim 15, having substantially a same hand feel and drape as the base fabric prior to application of the thermally conductive particles and the adhesive material thereto.

20. The thermally conductive fabric of claim 15, further comprising:
a web material over the thermally conductive particles, the adhesive material, and the lower surface of the base fabric.
